(19) United States
(12) Patent Application Publication
(10) Pub. No.: US 2002/0072937 A1
(43) Pub. Date: Jun. 13, 2002

(54) Travel fares packaging system and method

(76) Inventors: Sue Domenick, Elk Grove Village, IL (US); Robert L. Robless, Arlington Heights, IL (US)

Correspondence Address: BRINKS HOFER GILSON & LIONE, P.O. BOX 10395, Chicago, IL, 60610, US

(21) Appl. No.: 09/886,247

(22) Filed: Jun. 20, 2001

Related U.S. Application Data
(60) Provisional application No. 60/212,847, filed on Jun. 20, 2000.

(51) Int. Cl. G06F 17/60

(52) U.S. Cl. 705/5

(57) ABSTRACT

A system and method for packaging travel services for a customer is provided, wherein a travel package profile is defined. Communication is established with a plurality of travel service providers, wherein each of the providers is associated with one or more travel service inventories. A plurality of travel services available from the travel service inventories is identified, and one or more of the travel services is selected. The selected travel services are then presented as a travel package to the customer.

### RELATED APPLICATIONS

Applicants hereby claim priority under 35 U.S.C. §119(e) to provisional U.S. patent application Ser. No. 60/212,847, filed on Jun. 20, 2000, incorporated herein by reference.

Incorporated by reference are computer program listings attached as Appendices A and B. Appendices A and B are submitted concurrently herewith on a compact disc labeled by at least the title and inventors associated with this application. On the compact disc, Appendix A is contained within the file named “AppendixA.txt”, and is 320 kilobytes in size. Appendix B is contained within the file named “AppendixB.txt”, and is 3 kilobytes in size.

### BACKGROUND OF THE INVENTION

This invention relates to travel services. In particular, the present invention relates to systems and methods for conveniently packaging travel services for a customer.

In the travel industry, services are frequently bundled into a package for the convenience of customers. This packaging of travel services typically is marketed toward leisure travelers as opposed to business travelers. For instance, a travel package may provide a customer with one-stop shopping for an entire vacation, including airfare, lodging, ground transportation, and even recreational activities. Known methods of packaging travel services are employed by travel agents and wholesalers. Traditionally, wholesalers have packaged travel services and made the packages available to travel agents who then sold the packages to customers. More recently, wholesalers have begun to sell travel packages directly to customers via the Internet. In either case, the packages are created using a global distribution system such as Galileo or Sabre. Individual travel services are identified via the global distribution systems and combined into a package.

According to known methods, such services are usually pre-packaged for general marketing purposes. Alternatively, a custom package may be assembled in response to the parameters of a particular customer request. However, there are at least three significant limitations to known methods of custom travel service packaging. First, accessing the global distribution systems requires special proprietary computer terminals, which are not directly available to customers. Second, custom packages must be created manually, which requires significant time and effort. Third, not all available travel services are accessible via global distribution systems.

Global distribution systems maintain databases of travel service data on proprietary mainframe computers. Data pertaining to service availability and fares are collected from providers such as airlines, hotels, car rental agencies, and recreational/entertainment service providers and published on the proprietary databases. Travel agents and wholesalers then access the data via proprietary computer terminals that communicate with the mainframe computer. Neither these computer terminals nor the travel service data are directly available to customers.

Wholesalers offer some pre-packaged travel services to customers, usually via travel agents. However, if these pre-selected packages do not suit a customer's needs, the travel agent must manually select individual travel services, via the global distribution systems, to create a customized package. This process of creating custom travel packages using the global distribution systems is difficult and time-consuming. A more convenient system for packaging travel services is therefore needed. Preferably, this system would not involve proprietary computer hardware.

Although some known systems, such as current Internet-based travel agency systems, offer a certain degree of convenience for customers, these systems are still bound by the limitations of the global distribution systems. For instance, customers do not have access to all available travel services via the global distribution systems. The airline industry is an example of this. Airlines typically reserve a certain number of seats on each flight for leisure purposes. The fares associated with these seats are generally lower than standard full fares. Airlines usually publish fares for a flight many months in advance of the scheduled flight. At this time, both the lower leisure fares and the regular full fares are released for publication. The fare data are collected by a fare publisher such as the Airline Tariff Publishing Company (ATPCO). The fare publisher then distributes the fare data to the global distribution systems.

Using the proprietary terminals described above, travel agents and wholesalers access the fare data via the global distribution systems. Travel agents typically have access only to public fares on the global distribution systems. In contrast, wholesalers frequently have access to private fares that are arranged by agreement with specific service providers. The agreements typically require wholesalers to sell private fares only as part of a travel package. Service providers are able to restrict private fare access to only those wholesalers with whom the providers have these packaging agreements. As a result, travel agents do not have access to private fares, even for purposes of packaging.

Travel agents also may not have access to many short-term fares—fares for those services that are purchased shortly before they are to be used. As the scheduled date of departure for a given airline flight approaches, leisure fares are typically removed from the global distribution systems. After this time, the majority of leisure fares are no longer available via the global distribution systems. Because leisure travelers usually purchase airline tickets well in advance of their expected travel dates, demand for short-term leisure fares is usually low. These short-term leisure fares are part of a category referred to as special fares. The special fares category also may include other fares for which demand is lower than normal, or fares that are targeted at specific groups of customers. Airlines frequently desire to sell special fares without shifting demand from other markets such as business travel. Accordingly, airlines have sought ways to market special fares in a way that spurs demand without interfering with other markets. For instance, some airlines have offered short-term special fares through targeted marketing campaigns shortly before the departure date of a scheduled flight. However, other methods of marketing special fares are still needed.

Packaging provides an ideal vehicle for marketing special fares. For a number of reasons, however, service providers have been unable to market certain special fares through travel packages. For example, wholesalers generally require significant lead time to prepare a travel package. This type of lead time is not available when it comes to marketing short-term special fares. In addition, travel service providers have lacked the means to effectively collaborate with each other in an effort to combine their special fares into travel packages. Accordingly, there remains a need for a method of packaging special fares in packages with other travel services in a way that avoids interfering with other travel service markets. The method preferably would enable travel service providers to collaborate to create travel packages that suit their business needs.

It is, therefore, an object of the present invention to provide an improved system and method for conveniently packaging travel services for customers. It is also an object of the present invention to provide an improved system and method for customizing travel service packages in accordance with customer preferences. It is a further object of the present invention to provide an improved system and method for packaging special fares that avoids interfering with other travel service markets. It is an even further object of the present invention to provide an improved system and method for packaging travel services that enables service providers to collaborate in the creation of travel packages.

### BRIEF SUMMARY OF THE INVENTION

In accordance with the present invention, a system and method are described for packaging travel services for a customer.

According to one aspect of the present invention, there is provided a method of packaging travel services for a customer. The method includes defining a travel package profile. The method also includes communicating with a plurality of travel service providers, wherein each of the providers is associated with one or more travel services inventories. A plurality of travel services available from the travel service inventories are identified. One or more of the plurality of travel services is selected in accordance with the travel package profile. The selected travel services are then presented as a package to the customer.

According to another aspect of the invention, there is provided a system for packaging travel services for a customer. The system includes a travel package profile relating to a desired travel service package. Also provided is a market place engine, which is in communication with one or more provider inventory systems. The market place engine is programmable to query the provider inventory systems for updated provider inventory information. A dynamic packaging engine is in communication with both the market place engine and the customer preference database. The dynamic packaging engine is programmable to select a plurality of available travel services according to the updated provider inventory information and the travel service package profile. A customer interface is programmable to present the selected plurality of travel services as a package to the customer.

According to another aspect of the present invention, there is provided a system for packaging travel services for a customer. The system includes an exchange means for sharing information with one or more provider inventory systems to receive one or more updated inventories of available travel services. A packaging means, which is in communication with the exchange means, is provided for selecting a plurality of travel services from the inventories of available travel services. The selection of available travel services is based upon a travel package profile. A presentation means, which is in communication with the packaging means, is provided for presenting the selected travel services as a package to the customer.

### BRIEF DESCRIPTION OF THE DRAWINGS

The subsequent description of the preferred embodiments of the present invention refers to the attached drawings, wherein:

FIG. 1 shows a block diagram depicting a packaging system according to one presently preferred embodiment of the invention.

FIG. 2 shows a block diagram depicting in more detail the packaging system of FIG. 1.

FIG. 3 shows a flow diagram illustrating interactions with travel service providers in a packaging method according to another presently preferred embodiment of the invention.

FIG. 4 shows a flow diagram illustrating interactions with a customer and with travel service providers in a packaging method according to another presently preferred embodiment of the invention.

### DETAILED DESCRIPTION OF THE PREFERRED EMBODIMENTS

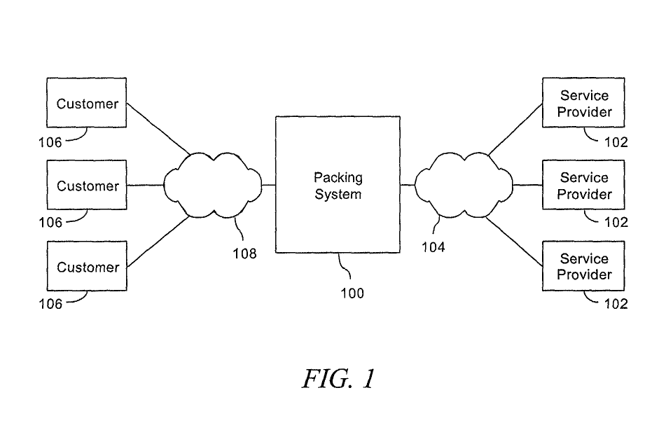

Referring now to the accompanying drawings, FIG. 1 shows a high-level block diagram depicting a packaging system 100 according to one presently preferred embodiment of the invention. The packaging system 100 shown in FIG. 1 is capable of creating packages of travel services according to at least three different scenarios. The first scenario may be referred to as packaging-on-demand. Packaging-on-demand involves the creation of a travel package in response to a particular customer request. In this case, the package is usually tailored to specific customer travel preferences, such as dates of travel, destination, preferred airline and accommodations, and preferred recreational or entertainment activities.

The second packaging scenario may be referred to as custom prepackaging. Custom pre-packaging involves the creation of a package based on stored customer preferences. The package is then pro-actively presented to the customer to entice the customer with a package that is tailored to the customer's known preferences.

The third packaging scenario may be referred to as general-availability packaging. General-availability packaging usually involves the creation of a package including travel services that service providers have a particular desire to sell, such as special fares. This allows service providers to market special fares through packages in a way that does not interfere with other travel service markets.

To accomplish these various methods of packaging, the packaging system 100 communicates with a plurality of travel service providers 102 via a distributed computer network 104. Communication with the travel service providers is accomplished independently of the proprietary global distribution systems. Preferably, the distributed computer network 104 comprises an extranet operating according to open-standard protocols and languages such as the Transmission Control Protocol/Internet Protocol (TCP/IP), the Hypertext Transfer Protocol (HTTP), and the Extensible Markup Language (XML). However, other protocols and languages known in the art are also appropriate for communications between the packaging system 100 and the service providers 102.

The packaging system 100 communicates with customers 106 via a second distributed computer network 108. This communication also is independent of the proprietary global distribution systems. Preferably, the second distributed computer network 108 comprises the Internet. In this case, communications between the packaging system 100 and the customers 106 include transmission of email messages and custom web pages.

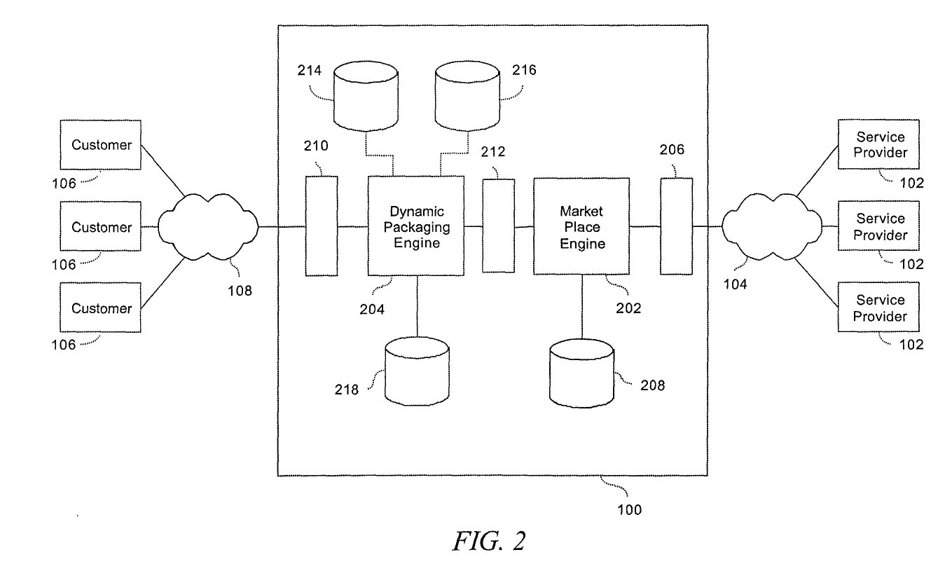

The packaging system 100 of FIG. 1 is shown in more detail in the block diagram of FIG. 2. The packaging system 100 includes a market place engine 202 and a dynamic packaging engine 204. Although in this preferred embodiment the market place engine 202 and the dynamic packaging engine 204 are shown as distinct components, it will be understood in the art that the functions of these two elements of the packaging system 100 may be combined into a single component.

The market place engine 202 communicates with travel service providers 102 via a business-to-business hub 206 and a distributed network 104, as described above. The market place engine 202 routes messages to travel service providers 102 to request and receive travel service inventory updates from the providers 102. Routing rules define the appropriate travel service provider(s) 102 for different types of messages. For instance, if a customer requests information on a European vacation package including a car rental, the market place engine 202 directs a request to only those car rental agencies that operate in Europe. Similarly, a bed-and-breakfast may request a rule dictating that the bed and breakfast not receive requests for lodging in connection with bus tours because it does not have the capacity to host large tour groups. Through this communication with travel service providers 102, the market place engine 202 is able to exchange inventory information between the service providers 102 and the packaging system 100. In this sense, the market place engine 202 is preferably in direct communication with the inventory systems of the travel service providers 102 to ensure that the information transferred is as accurate and current as possible. The market place engine 202 also may maintain current service provider inventory information locally in an offering repository 208.

The dynamic packaging engine 204 communicates with customers 106 via customer interface 210 and distributed network 108. Preferably, the dynamic packaging engine 204 communicates with the market place engine 202 via a market place engine interface 212. Depending upon the configuration of the packaging system 100, however, communication between the market place engine 202 and the dynamic packaging engine 204 may not require the presence of a market place engine interface 212. In either case, the dynamic packaging engine 204 is capable of receiving service provider inventory information from the market place engine 202 and using the inventory information to create custom packages of travel services. According to the methods described below, the dynamic packaging engine 204 also communicates with customers 106 via the customer interface 210 to receive customer requests and to present travel service packages to the customers 106. The customer interface includes an HTTP server capable of transmitting custom web pages to customers 106 via the World Wide Web. The customer interface also may include an email server, such as a Simple Mail Transfer Protocol (“SMTP”) server, capable of sending custom email messages to customers 106 via the Internet. For instance, email messages may include offers for custom pre-packaged travel services or for general-availability packages. The dynamic packaging engine 204 also communicates with customers 106 via the customer interface 210 and with the market place engine 202 via the market place engine interface 212 to receive and fulfill customer orders for travel service packages. For instance, after being presented with a travel package, a customer 106 may transmit an order to purchase the package via the customer interface 210. The dynamic packaging engine 204 receives the customer order and communicates with the appropriate travel service providers 102 via the market place engine 202 to confirm availability of the packaged travel services and to reserve those services on behalf of the customer 106.

The packaging system 100 also may include a customer preference repository 214, which contains information regarding customer travel preferences. The dynamic packaging engine 204 may access the customer repository 214 and use the customer travel preferences to proactively create custom travel packages for presentation to the customer. Customer travel preferences may include, for example, a customer's favorite travel destinations and activities. Customer travel preferences also may include details regarding a customer's preferred hotel room type, rental car class, airline seating class, destination, and recreational or entertainment activities desired.

A marketing campaign repository 216 also may be included in the packaging system 100. The marketing campaign repository 216 stores information regarding specific marketing campaigns. Marketing campaigns are designed to package specific travel services that service providers 102 wish to sell as part of a travel package. For instance, marketing campaigns may be designed to package special fares in the form of a general-availability travel package. Campaign parameters defining the marketing campaign are contained in the marketing campaign repository 216 and used by the dynamic packaging engine 204 to create specific travel packages in accordance with the marketing campaign.

The packaging system also may included a packaging repository 218. The packaging repository 218 contains information regarding pre-packaged travel services. These packages, which are also created by the dynamic packaging engine 204, are typically general-interest in nature. For instance, the packaging repository 218 may contain packages that were created as part of a marketing campaign, possibly to promote special fares. The packages contained in the packaging repository 218 may be presented to customers in response to requests for pre-packaged travel services as opposed to custom travel packages.

In a preferred embodiment of the packaging system 100, the dynamic packaging engine 204 is embodied by a software program such as one compiled from the source code included in Appendix A. Appendix A includes source code for forty-five JAVA components that may be combined according to methods known in the art to form a preferred embodiment of the dynamic packaging engine 204. The market place engine 202 preferably is embodied by the WebLogic Collaborate software running on a WebLogic 5.1 application server, both commercially available from BEA Systems, Inc. The market place engine interface 212 preferably is embodied by a software program such as one compiled from the source code included in Appendix B. Appendix B includes source code for two JAVA components that may be combined according to methods known in the art to form a preferred embodiment of the market place engine interface 212. The offering repository 208, the customer repository 214, the marketing campaign repository 216, and the package repository 218 preferably are hosted in an Oracle 8i database application, which is commercially available from Oracle Corporation of Redwood Shores, Calif. These systems preferably are maintained on a Sun Enterprise 450 server, commercially available from Sun Microsystems of Palo Alto, Calif.

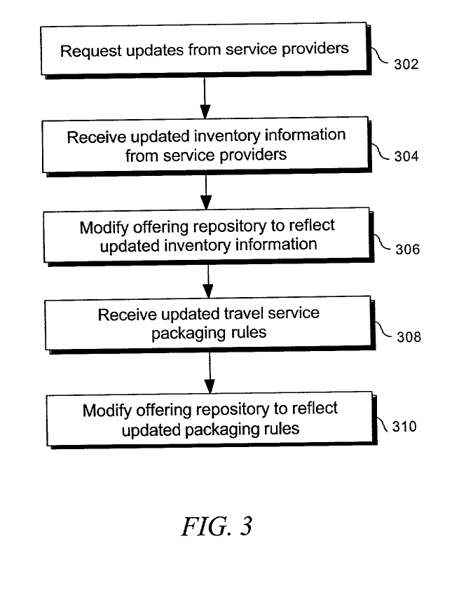

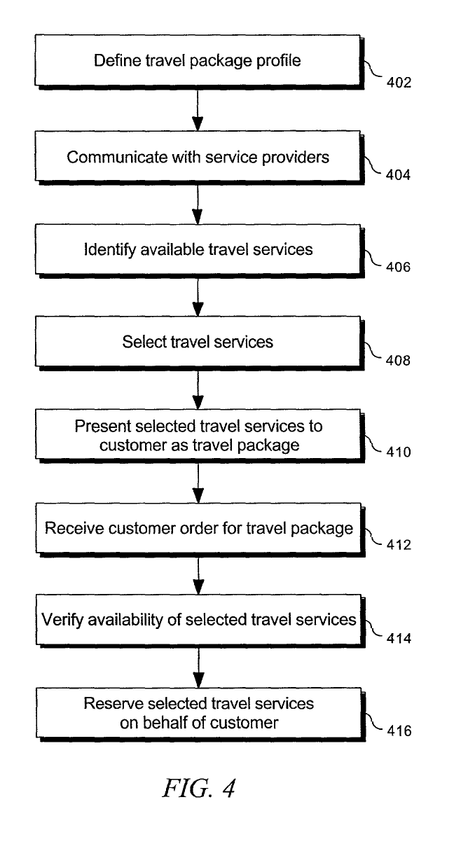

The operational methods of the packaging system will now be discussed with reference to FIGS. 3 and 4. FIG. 3 shows a flow diagram illustrating interactions with travel service providers to receive updated inventory information. In step 302, the market place engine 202 of the packaging system 100 sends a request to the travel service providers 102 for updated inventory information. As described above, this communication is preferably sent directly to the service providers' inventory systems. The market place engine 202 then receives the most current inventory information from the travel service providers 102 in step 304. Optionally, the process may begin automatically with step 304. In this case, the travel service providers 102 send updated inventory information to the dynamic packaging engine 202 without prompting, possibly according to a prearranged update schedule. Once the dynamic packaging engine 202 has received updated inventory information from a service provider, the dynamic packaging engine 202 updates the offering repository to reflect this new information in step 306. In this way, the packaging system 100 maintains a local database of travel service provider offerings. Similarly, the market place engine 202 also may receive updated travel service packaging rules and routing rules from the service providers 102 in step 308. The packaging rules define how various travel services may validly be combined to form a travel package. For instance, a rental car provider may offer a discount for its services when packaged in combination with airfare from a particular airline. The routing rules define how the market place engine 202 should route messages to particular service providers 102, as described above. After receive the rule update, the market place engine 202 updates the offering repository 208 to reflect any new packaging or routing rules in step 310.

FIG. 4 shows a flow diagram illustrating interactions with a customer 106 and any necessary travel service providers 102 in the context of preparing a travel package for the customer 106. A custom travel package may be prepared on demand (in response to a specific customer request) or proactively pre-packaged and customized in accordance with stored customer preferences. A general-availability package may be created according to the parameters of a specific marketing campaign. For instance, a campaign may be initiated to market packages including special fares from various service providers. In any of these cases, the first step 402 is to define a travel package profile. If the package is created on demand, the package profile is defined by receiving a customer request via the customer interface 210, identifying relevant customer travel preferences, and including these travel preferences in the travel package profile. The customer preferences may derive from the customer request itself, if the customer indicated specific preferences for the present travel package. Alternatively, the relevant customer preferences may be obtained from the customer repository 212, which includes preferences associated with the customer during previous transactions. If a custom travel package is prepared proactively (not in response to a specific customer request), then the relevant customer travel preferences will generally be obtained from the customer repository 212.

Whether the travel package is prepared on demand, custom prepackaged, or packaged for general availability, the next steps are to communicate with travel service providers (step 404) and to identify relevant and available travel services (step 406). The packaging system 100 may first check the offering repository 208 for relevant travel services. In this case, the step 404 of communicating with travel service providers 102 will have been performed previously during the process of updating the offering repository as described in connection with FIG. 3. If, however, the necessary travel services cannot be identified in the offering repository 208, the packaging system 100 sends a specific request to the travel service providers 102 for travel service inventory information relevant to the customer's request. Preferably, the dynamic packaging engine 204 creates this request and sends it to the market place engine 202. The market place engine 202 engine then forwards the request to the appropriate travel service providers 102 and then receives any new responsive inventory information from the service providers 102.

Once the available travel services have been identified, the dynamic packaging engine 204 selects particular travel services for packaging according to the travel package profile in step 408. In selecting travel services, the dynamic packaging engine 204 applies any necessary packaging rules received from the service providers 102. The packaging system 100 then presents the selected travel services as a package to the customer 106 via the customer interface 210 in step 410. Presentation of the travel package may occur in a number of ways. For instance, if the travel package is prepared on demand, the packaging system 100 may present the package to the customer 106 in the form of a custom web page. Alternatively, if the package is prepared proactively or for general availability, the packaging system 100 may present the package in the form of an email message to the customer 106. In a third alternative, the packaging system 100 may notify the customer 106 of a proactively-generated custom travel package or general-availability package via an email message. In this case, the email message would invite the customer 106 to visit a custom web page for presentation of the travel package.

Should the customer 106 decide to purchase the custom travel package, the packaging system 100 next receives the customer's order for the package in step 412. The dynamic packaging engine 204 then sends a message to the market place engine 202, causing the market place engine 202 to contact the appropriate travel service providers 102 and verify continuing availability of the selected travel services in step 414. If the selected travel services are still available, the market place engine 202 reserves the selected services on behalf of the customer 106 in step 416.

The invention has been described in detail with particular reference to preferred embodiments thereof and illustrative examples, but it will be understood that variations and modifications can be effected within the spirit and scope of the invention.

1. A method of packaging travel services for a customer comprising the steps of:
defining a travel package profile;
communicating with a plurality of travel service providers, wherein each of said plurality of providers is associated with one or more travel service inventories;
identifying a plurality of travel services available from said travel service inventories;
selecting two or more travel services from said plurality of travel services in accordance with said travel package profile; and
presenting said two or more selected travel services as a travel package to said customer.

2. A method of packaging travel services according to claim 1, wherein said plurality of travel services includes one or more of the following: transportation services; lodging services; recreational services, and entertainment services.

3. A method of packaging travel services according to claim 1, wherein said step of communicating with a plurality of travel service providers is performed via an open-standard distributed computer network.

4. A method of packaging travel services according to claim 1, wherein said step of defining a travel package profile further comprises the steps of:
identifying one or more relevant customer travel preferences; and
including said customer travel preferences in said travel package profile.

5. A method of packaging travel services according to claim 4, wherein said step of identifying one or more relevant customer travel preferences further comprises the steps of:
receiving a customer request including a plurality of customer travel preferences; and
selecting said one or more relevant customer travel preferences from said plurality of received customer travel preferences.

6. A method of packaging travel services according to claim 4, wherein said step of identifying one or more relevant customer travel preferences further comprises the steps of:
accessing a database containing a plurality of customer preferences compiled in connection with one or more previous transactions with said customer; and
selecting said one or more relevant customer travel preferences from said plurality of customer travel preferences.

7. A method of packaging travel services according to claim 1, wherein said step of defining a travel package profile further comprises the steps of:
identifying one or more marketing campaign parameters; and
including said marketing campaign parameters in said travel package profile.

8. A method of packaging travel services according to claim 1, wherein said step of presenting said two or more selected travel services as a custom travel package to said customer further comprises the step of:
creating a custom email message containing a description of said custom travel package;
transmitting said custom email message to said customer.

9. A method of packaging travel services according to claim 1, further comprising the step of:
receiving a request from said customer via a travel service request web page; and
wherein said step of presenting said two or more selected travel services as a custom travel package to said customer includes:
creating a custom web page containing a description of said custom travel package; and
transmitting said custom web page to said customer.

10. A method of packaging travel services according to claim 1, further comprising the steps of:
maintaining an offering repository of one or more of said travel service inventories associated with said plurality of travel service providers;
periodically receiving travel service inventory updates from one or more of said plurality of travel service providers; and
updating said offering repository in accordance with said travel service inventory updates.

11. A method of packaging travel services according to claim 1, further comprising the step of:
receiving a plurality of travel service rules from one or more of said plurality of travel service providers; and
wherein said step of selecting two or more travel services includes applying said travel service rules to ensure that said selected travel services form a valid custom travel package.

12. A method of packaging travel services according to claim 1, further comprising the steps of:
receiving an order for said custom travel package from said customer; and
reserving said selected two or more selected travel services for said customer.

13. A method of packaging travel services for a customer, comprising the steps of:
communicating with a plurality of travel service providers, wherein each of said plurality of providers is associated with one or more travel service inventories;
identifying a plurality of travel services available from said travel service inventories, wherein said plurality of travel services includes a plurality of special fare travel services;
selecting two or more travel services from said plurality of travel services, wherein said selected two or more travel services includes at least one special fare travel service selected from said plurality of special fare travel services; and
presenting said selected travel services as a travel package to said customer.

14. A system for packaging travel services for a customer, said system comprising:
a travel package profile including at least a plurality of data relating to a desired travel service package;
a market place engine in communication with one or more travel service provider inventory systems, said market place engine being programmable to query said travel service provider inventory systems for updated travel service provider inventory information;
a dynamic packaging engine in communication with said market place engine and said customer preference database, said dynamic packaging engine being programmable to select a plurality of available travel services according to said updated travel service provider inventory information and said plurality of data included in said travel package profile; and
a customer interface programmable to present said selected plurality of travel services as a package to said customer.

15. A system for packaging travel services for a customer as in claim 13, wherein:
said dynamic packaging engine is further programmable to receive an order from said customer for said selected travel services; and
said market place engine is further programmable to reserve said selected travel services on behalf of said customer.

16. A system for packaging travel services for a customer as in claim 13, further comprising:
a customer preference repository including a plurality of customer travel preferences associated with said customer;
wherein said travel package profile includes one or more of said plurality of customer travel preferences.

17. A system for packaging travel services for a customer as in claim 13, further comprising:
a marketing campaign repository including a plurality of marketing campaign parameters; and
wherein said travel package profile includes one or more of said marketing campaign parameters.

18. A system for packaging travel services for a customer as in claim 13, wherein said market place engine further comprises:
an offering repository capable of storing said travel service provider inventory information.

19. A system for packaging travel services for a customer as in claim 13, further comprising:
a market place engine interface programmable to facilitate communication between said market place engine and said dynamic packaging engine.

20. A system for packaging travel services for a customer as in claim 14, wherein said customer interface further comprises:
a hypertext transfer protocol server capable of presenting custom web pages to said customer via the World Wide Web.

21. A system for packaging travel services for a customer as in claim 14, wherein said customer interface further comprises:
an email server capable of sending email messages to, and receiving email messages from, said customer via the Internet.

22. A system for packaging travel services for a customer, said system comprising:
an exchange means for sharing information with one or more travel service provider inventory systems to receive one or more updated inventories of available travel services;
a packaging means, in communication with said exchange means, for selecting a plurality of travel services from said inventories of available travel services, wherein said selection is based upon a travel package profile; and
a presentation means, in communication with said packaging means, for presenting said selected plurality of travel services as a package to said customer.

23. A system for packaging travel services for a customer as in claim 22, said system further comprising:
a storage means for storing a plurality of customer travel preferences associated with said customer;
wherein said package profile includes one or more of said plurality of customer travel preferences.

24. A system for packaging travel services for a customer as in claim 22, said system further comprising:
a storage means for storing a plurality of marketing campaign parameters;
wherein said package profile includes one or more of said plurality of marketing campaign parameters.

25. A system for packaging travel services for a customer, said system comprising:
an exchange means for sharing information with one or more travel service provider inventory systems via an open-standard distributed computer network to receive one or more updated inventories of available travel services associated with one or more travel service providers;
a storage means for storing said updated inventories of available travel services;
a packaging means, in communication with said exchange means, for selecting a plurality of travel services from said inventories of available travel services, wherein said selection is based upon a package profile;
a presentation means, in communication with said packaging means, for presenting said selected plurality of travel services as a package to said customer via a TCP/IP network;
an order processing means for receiving and processing orders for said selected plurality of travel services from said customer via said TCP/IP network; and
a fulfillment means for sharing information with one or more of said travel service providers via said open-standard distributed computer network to reserve said selected plurality of travel services on behalf of said customer.

26. A system for packaging travel services for a customer as in claim 25, said system further comprising:
a plurality of customer travel preferences associated with said customer;
wherein said package profile includes one or more of said plurality of customer travel preferences.

27. A system for packaging travel services for a customer as in claim 25, said system further comprising:
a plurality of marketing campaign parameters;
wherein said package profile includes one or more of said plurality of marketing campaign parameters.
